(19) United States
(12) Patent Application Publication
(10) Pub. No.: US 2014/0008209 A1
(43) Pub. Date: Jan. 9, 2014

(54) METHOD AND DEVICE FOR PERFORMING QUANTUM CONTROL ON INFINITESIMAL QUANTA

(71) Applicant: GOW-LIN LAM, Penang (MY)

(72) Inventor: GOW-LIN LAM, Penang (MY)

(21) Appl. No.: 13/962,924

(22) Filed: Aug. 8, 2013

Related U.S. Application Data
(63) Continuation-in-part of application No. 13/542,653, filed on Jul. 5, 2012, now abandoned.

(51) Int. Cl. B01J 19/12

(52) U.S. Cl. CPC B01J 19/12
USPC 204/157.15; 422/186

(57) ABSTRACT

A method for performing quantum control on infinitesimal quanta includes: an independent reaction space provision step, wherein at least one three-dimensional closed space is provided; an infinitesimal-quantum kinetic energy enhancement step, wherein differently shaped reaction elements are provided on at least one inner surface of each closed space, each reaction element having at least two slits and plural pores; a parameter control step counted by time with the unit of second, wherein at least a first reaction parameter is provided, and, upon occurrence thereof, wave control is performed on a corresponding one of the at least one closed space. The method provides an executable quantum control mechanism which is meaningful in terms of reaction and capable of modifying the properties of matter in a purely physical manner, such that a wavefunction is controlled to provide different energies, thereby providing assistance to environmental improvement techniques, agricultural techniques, and traditional medical techniques.

### CROSS-REFERENCE TO RELATED APPLICATION

This application is a continuation-in-part of U.S. patent application Ser. No. 13/542,653, filed Jul. 5, 2012, which is continuation-in-part of U.S. patent application Ser. No. 12/591,692, filed Nov. 30, 2009 and now abandoned, priority of the filing date of which is hereby claimed under 35 U.S.C. §120.

### BACKGROUND OF THE INVENTION

1. Technical Field

The present invention relates to a method and device for performing quantum control on infinitesimal quanta, wherein the traditional quantum theory is integrated with an experiment structure, and wherein control elements work in conjunction with time parameters and space so as to enable infinitesimal quanta to react. The method and device disclosed herein are applicable to various matters and capable of modifying the physical properties thereof, thereby expanding the application of quantum mechanics to daily life.

2. Description of Related Art

As the minimum amount of any matter involved in an interaction, quanta exhibit wave-particle duality and produce such phenomena as interference, refraction, and superposition in a double-slit experiment. Quanta of matter or energy are omnipresent if it were possible to simultaneously perform a measurement for every type of quantum particle at every point in space at the same time. In the study of quantum motion, the phenomenon of quantum motion itself can be verified only with an experiment structure designed according to variation of infinitesimal quanta. Furthermore, the world of matter defined in terms of electromagnetic waves can be understood and characterized only by way of quantum mechanics, though to a limited extent. Theoretically, from the perspective of quantum mechanics and in the atom level of matter, when the pattern or energy level of an orbital electron cloud changes, the physical properties of the matter changes accordingly. Hence, there is a trend in material science and applied science to explore and control ever smaller scales so as to provide an infinitesimal-quantum control technique based on quantum physics.

However, due to the following limitations, existing theories and experiment structures of quantum mechanics are still incapable of providing practical quantum control over infinitesimal quanta:

1. Limitation of energy sources: It is well known that the natural space and all matters are composed of waves and particles, wherein the types, generation methods, and control mechanisms of the waves and particles are infinite. Nevertheless, knowledge of corresponding reactions between the waves and particles is lacking, so these reactions cannot be effectively used as a basis of infinitesimal-quantum reaction.

2. Uncertainty of quantum motion: According to Heisenberg's uncertainty principle, it is impossible to make equally accurate observations of position and momentum, as briefly explained below. While the lightest photon has zero rest mass, the electron is also very small. In order to “see” clearly, the wavelength λ of the photon must be slightly smaller than the object to be seen. Given p=h/λ (where p represents momentum of photon, h represents the Planck constant, and λ represents wavelength of photon), the smaller the wavelength λ is, the greater the momentum p of the photon will be. When “observation” takes place, i.e., when light “sees” an electron, or more correctly speaking, when a photon hits the electron, if the photon is a high momentum particle, then the electron hit by the photon immediately acquires a high momentum whose magnitude and direction are unpredictable. As a result, there must be an error in the magnitude of the observed momentum of the electron. To prevent the electron from straying when being “observed”, the photon must have low momentum and, consequently, a very long wavelength. Under such circumstances, the position of the electron can only be vaguely seen. Thus, position and momentum cannot be observed with equal accuracy.

3. Confinement to pure academic research: As infinitesimal quanta are present in very small quantity but unlimited combinations, it is extremely difficult to calculate and control infinitesimal quanta. Apart from that, diffusion of particles and waves in space interferes with infinitesimal quanta and renders the moving paths of infinitesimal quanta so elusive that the moving paths defy systematic categorization, repetition, or even explanation. For the above reasons, infinitesimal quanta have not found effective applications. Nowadays, scientists can only build large accelerators to exclude environmental interference and conduct pure academic studies on infinitesimal quanta.

### BRIEF SUMMARY OF THE INVENTION

It is an objective of the present invention to provide a method and device based on the concept of wavefunction and configured for performing quantum control on infinitesimal quanta. By enabling infinitesimal quanta in space to undergo effective reaction, the method is freed from the limitation of energy sources, overpasses the innumerable combinations of control factors, and prevents the interference of waves and particles in natural space. Thus, the method provides an executable quantum control mechanism which is meaningful in terms of reaction and capable of modifying the properties of matter in a purely physical manner, such that a wavefunction is controlled to provide different energies, thereby aiding in environmental improvement techniques, agricultural cultivation and planting techniques, and traditional medical techniques.

It is another objective of the present invention to provide a method for performing quantum control on infinitesimal quanta, wherein the method is not limited in the choices of energy sources but is intended to capture the waves and particles diffused in space, thereby challenging the traditional theory that the types of waves and particles must be specified in advance. This is because, if the waves and particles are specified, the matching between expected results and the corresponding matters will be as difficult and fruitless as finding a needle in a haystack. Moreover, if the waves and particles are limited to those which are artificially supplied and have high energy or high frequency, there will be safety, cost, popularity, and applicability issues to be considered, and in consequence the use value is limited by the limitation on energy sources.

The method for performing quantum control on infinitesimal quanta according to the present invention is also intended to follow the uncertainty principle and dispense with measuring particle movement. In the present invention, the reaction process and results are more important than “certainty in measurement”. Therefore, the temporal and spatial components of a wavefunction according to the present invention are limited, regulated, and standardized as control parameters. By so doing, the traditional theory that a motion must be understood before being controlled is dismissed, and thus feasible development of quantum control in no longer hindered by uncertainty in measurement.

The method for performing quantum control on infinitesimal quanta according to the present invention is further intended to be based on practical value and take into account the practical requirements for quantum control in natural environment, so as not to exclude any waves and particles diffused in space. The method of the present invention is also intended to be based on infinitesimal-quantum control of the experiment structures of classical quantum mechanics, such that the focus of research is placed not on particle intensity but on waves, thereby eliminating the blind spot of the traditional theory that quantum motion must be generated by high energy. Thus, the present invention creates an executable quantum control mechanism which is meaningful in terms of reaction and capable of modifying the properties of matter in a purely physical manner, wherein a wavefunction of the present invention is controlled to provide different energies, thereby providing assistance to environmental improvement techniques, agricultural cultivation and planting techniques, and traditional medical techniques.

The method for performing quantum control on infinitesimal quanta, based on fundamental physics and Young's double-slit theory, with multiple pores formed on metal plates in a consistent and tight arrangement, is intended to destroy or debond attraction (bonding) among particles by the actuation of time (second) and space (three-dimensional), and to immediately bring another bonding or particle at the moment of the disappearance of previous bonding based on the law of conservation of matter, whereby to change chemical compound characteristics of a matter. The method includes an independent reaction space provision step, an infinitesimal-quantum kinetic energy enhancement step, and a parameter control step.

In the independent reaction space provision step, at least one cubic closed space is provided. Each closed space defines therein a range of action, i.e., (x, y, z) of a wavefunction, wherein x-axis, y-axis, and z-axis that are equal in length with each other, for particles and waves of infinitesimal quanta, so as to obtain balanced reaction conditions.

As is known that the wavefunction describes the quantum state of a particle and how it behaves. According to Schrodinger equation, wavefunction Ψ(r, t) is a multivalued function representing a position (r) of a particle and a probability amplitude of time (t), and thus wavefunction is a probability wave for measuring the position (x) in an interval (meaning a≦x≦b is P_{a≦x≦b}=∫|Ψ(x, t)|²dx, where t is the time at which the position of the particle is measured. In other words, |Ψ(x, t)|² is the probability density that the particle is at (x) and time (t), so there is 100% probability that the particle will be found in a space:

$${\int }_{- ∞}^{∞} {\vert Ψ ( x , t ) \vert}^{2} d x = 1.$$

In Momentum-space the particle also has a wavefunction: Φ(p,t); where p is the momentum in one dimension, which can be any value from −∞ to +∞, so the result is not deterministic, but is described by a probability distribution. The probability of the momentum p in the interval [a, b] (i.e. a≦x≦b) is

$${P}_{a < p < b} = \int {\vert Φ ( p , t ) \vert}^{2} d p .$$

The normalization condition of the momentum-space wavefunction is similar as the probability of finding the particle in the position-space:

$${\int }_{- ∞}^{∞} {\vert Φ ( p , t ) \vert}^{2} d p = 1$$

The probability of superposition of wavefunctions is determined by a phase difference between two wavefunctions; that is, Young's double-slit experiment performed by the plurality of mesh plates in the present invention. Accordingly, the wavefunction in the present invention is probabilistic quantum action, and is also dependent on space (position) and time (time of reaction and stop reaction is counted by second), where a reaction space of the present invention is within a square three-dimensional closed space.

In the infinitesimal-quantum kinetic energy enhancement step, reaction elements of different geometric shapes are provided on at least one of the six inner surfaces of each cubic closed space. Each reaction element is consisted of a plurality of mesh plates being overlapped and metal plates sandwiched between the mesh plates, each of the mesh plates forming multiple pores such that, while particles and waves in the each said closed space pass through tiny lattices (i.e., slit structures) formed by the overlapped mesh plates and arranged in an asymmetric way to move and exhibit potential differences in a probabilistic quantum effect when performing Young's double-slit experiment, free waves in the each said closed space are adjusted so as to produce interference and superposition effects, thereby creating wave beams as a basis of infinitesimal-quantum reaction, whereby the wave beams, waves being sorted, and particles from the plurality of mesh plates and the metal plates cooperatively reaching a wavelength (wave frequency) that corresponds to hydrogen bond thereby to change characteristics or entire clusters of chemical compounds of the to-be-processed matter and to form smaller cage-like elements under effectively actuating in a direction of the wave beams.

The parameter control step being counted by time with a time unit of “second”, comprises: a first reaction parameter defined by a time that the to-be-processed matter remains in the three-dimensional closed space, and a second reaction parameter defined by a time that the to-be-processed matter is exposed to the atmosphere;

with the above-mentioned steps, the particles and waves of the infinitesimal quanta in the universe through the plurality of mesh plates, double-slit reaction and repeatedly reflection or sorting between the metal plates exhibit directionality and specific wave frequency, and after reaction with the first reaction parameter observe change of physical and chemical characteristics of the to-be-processed matter during which quanta in atoms is in a process of permutation, or electron energy levels are in drastically change, or covalent bonds among atoms are cracked, and polar bonds of the chemical compounds bonding with hydrogen bonds exhibit greater polarity through enhanced resonance of effectively bunching and directional wave frequency and particles, and through constructive interference of effectively bunching and directional wave frequency and particles the chemical compounds resonate with greater amplitudes causing agitation of chemical compound particles, whereby enhancing the physical and chemical characteristics of the chemical compounds, or through destructive interference of effectively bunching and directional wave frequency and particles the polarity of the chemical compounds transiently disappears where the chemical compounds temporarily lost attracting and spinning reaction and thus cluster structure of the chemical compounds and the chemical compound particles is being changed so as to realize quantum control on infinitesimal quanta.

In accordance with the present invention, the metal plates each having an irregular surface and made of aluminum are configured to enable low-energy waves and particles to be reflected in each said closed space and act repeatedly in the reaction elements until energy levels (frequencies) of the low-energy waves and particles are increased through repeated interference and superposition to such extent that the originally low-energy waves and particles can now penetrate the metal plates, thereby enhancing kinetic energy of the low-energy waves and particles.

Moreover, the second reaction parameter of the parameter control step for performing time interval control between consecutive uses of a plurality of the independent reaction spaces, so as to achieve continuous equilibrium with electromagnetic waves in the atmosphere. Thus, the traditional thermodynamic principles are satisfied, and the results are stable.

### BRIEF DESCRIPTION OF THE SEVERAL VIEWS OF THE DRAWINGS

The invention as well as a preferred mode of use, further objectives, and advantages thereof will be best understood by referring to the following detailed description of illustrative embodiments in conjunction with the accompanying drawings, in which:

FIG. 1 is a block flow diagram of a method for performing quantum control on infinitesimal quanta according to the present invention;

FIG. 2A and FIG. 2B are schematic views of a device for performing quantum control on infinitesimal quanta according to the present invention;

FIG. 2C is a schematic exploded view of a reaction element of the device for performing quantum control on infinitesimal quanta according to the present invention;

FIGS. 2D and 2E are schematic views respectively showing a side plan view of the reaction element for indicating a direction of light projecting, and a wavy effect of waves according to the present invention;

FIGS. 3A to 3G are perspective views of three-dimensional closed spaces according to the present invention, wherein the three-dimensional closed spaces are installed respectively with reaction elements of various configurations;

FIG. 4 illustrates an embodiment of the method for performing quantum control on infinitesimal quanta according to the present invention, wherein a plurality of independent reaction spaces are used consecutively; and

FIGS. 5A to 5D illustrate another embodiment of the method for performing quantum control on infinitesimal quanta according to the present invention, wherein the matter to be processed, i.e., mineral water, is treated successively by four three-dimensional closed spaces with different reaction elements.

### DETAILED DESCRIPTION OF THE INVENTION

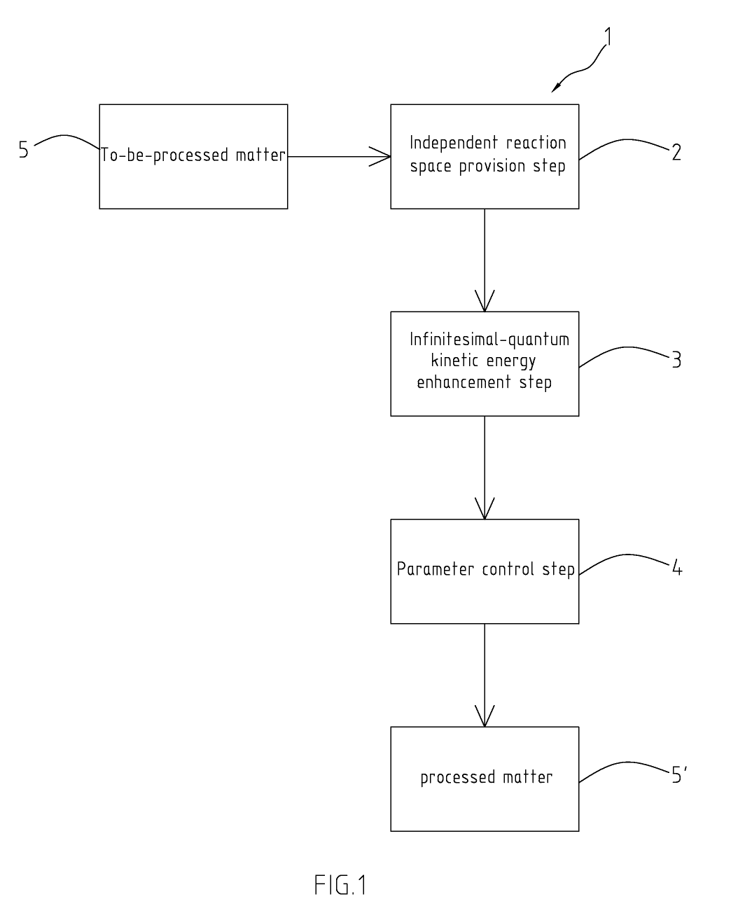

Referring to FIG. 1, a method 1 for performing quantum control on infinitesimal quanta includes an independent reaction space provision step 2, an infinitesimal-quantum kinetic energy enhancement step 3, and a parameter control step 4.

In the independent reaction space provision step 2, at least one three-dimensional closed space is provided. An independent closed space is one of required elements for a certain type of quantum motion. In the fact that electromagnetic waves are non-directional and spread in the air, and in order to obtain balanced reaction conditions and limit a range of action for a to-be-processed matter and for particles and waves of infinitesimal quanta, the closed space in the preferred embodiment has a cubic shape. The cubic closed space is configured to create various angles so as to generate potential differences and facilitate particles movement and exhibition. Furthermore, the present invention can utilizes not only a single three-dimensional closed space but also a plurality of three-dimensional closed spaces operated in combination for providing various control parameters.

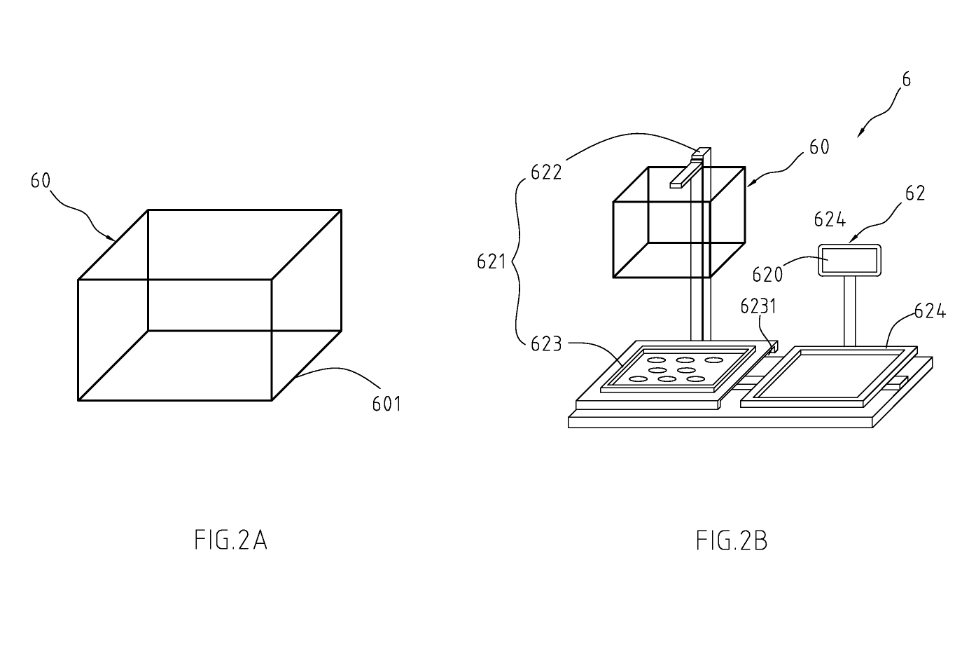

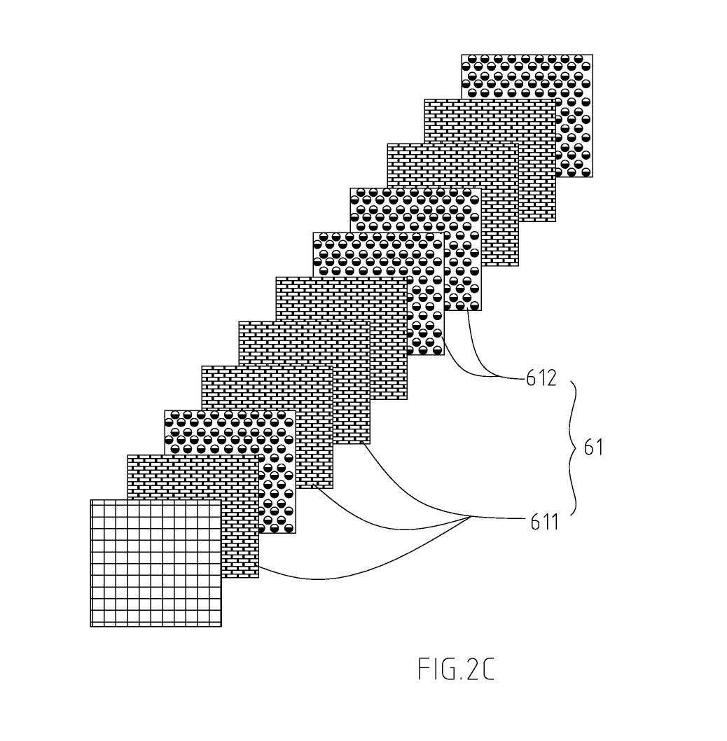

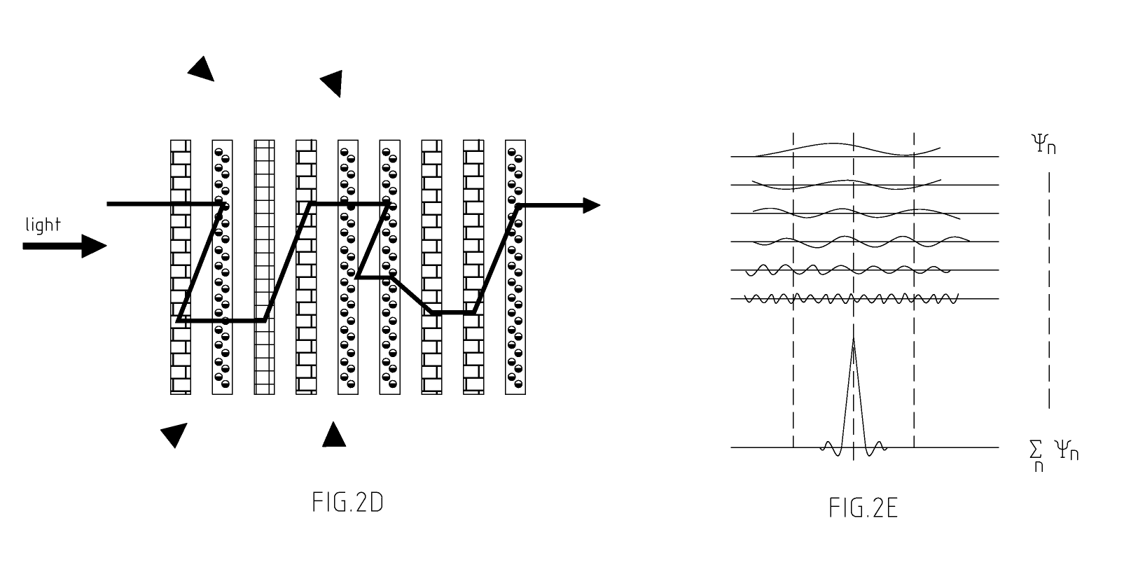

In the infinitesimal-quantum kinetic energy enhancement step 3, at least one reaction element is provided on at least one inner surface of each of the at least one closed space, wherein in case a plurality of such reaction elements are provided, the reaction elements have different geometric shapes. Each reaction element is consisted of a plurality of mesh plates being overlapped and metal plates sandwiched between the mesh plates. Each of the mesh plates forms multiple pores such that, while particles and waves in the each said closed space pass through tiny lattices (i.e., slit structures) formed by the overlapped mesh plates and arranged in an asymmetric way to move and exhibit potential differences, free waves in each closed space are adjusted so as to produce interference and superposition effects. Consequently, wave beams are generated as a basis of infinitesimal-quantum reaction. Referring to FIG. 2C, each reaction element 61 is consisted of a plurality of mesh plates 611 being overlapped and metal plates 612 sandwiched between the mesh plates 611, wherein each of the mesh plates 611 is made of nylon forming multiple pores thereon. The number of pores (i.e., density of pores) of the mesh plate is defined by the number of stitches of the nylon mesh plate. In other words, the more the stitches per square inch are, the more the pores are formed. In order to produce a three-dimensional structure of diverse interference and refraction, the mesh plate is preferably made of nylon having numerous stitches, and the metal plates are made of aluminum. In particular, the number of layers of the nylon mesh plates 611 and the aluminum metal plates 312 both being overlapped has to be stipulated. Specifically, the mesh plates 611 having different number of stitches (pores) are overlapped in a specific order. For example, a mesh plate 611 of 120 stitches per square inch and a mesh plate 611 of 100 stitches per square inch are to be overlapped together so as to increase thickness of the reaction element, thereby to create unaccountable and complex three-dimensional pore structure. Accordingly, a different order of overlap results in a different interference and refraction structure causing a different experimental result. Likewise, the metal plates 612 sandwiched in a different layer of the mesh plates lead to a different result. Furthermore, the metal plates 612 of irregular surfaces that are disposed towards different directions also affect a whole structure for performing quantum control on infinitesimal quanta. As a result, the reaction element of the present invention is consisted of multiple layers overlapped in such a way that each layer is overlapped one by one first, and then multiple layers are put together to overlap at a time.

In addition to the pores formed in internal portions of the reaction element 61, a profile of the reaction element 61 is to determine a contact type of a reaction area in a three-dimensional array. Therefore, the reaction element 61 preferably has a geometric shape selected from the group consisting of a dumbbell shape, a cross, a triangle, a rectangle, a square, a trapezoid, and a lightning shape. Moreover, the reaction elements 6 are capable of being arranged in a dot matrix array for reaction with a whole surface of the reaction area. Alternatively, the reaction element 61 is capable of being shaped as a round reaction plate having a diameter of one centimeter, and then the reaction area thereof is expanded and extended from point to line to plane.

Referring to FIGS. 2D and 2E, when light projects into the reaction element 61, low-energy waves and particles are reflected in each said closed space and act repeatedly in the reaction elements until energy levels (frequencies) of the low-energy waves and particles are increased through repeated interference and superposition to such extent that the originally low-energy waves and particles can now penetrate the metal plates, thereby enhancing kinetic energy of the low-energy waves and particles.

In addition to the closed space as described above, time is another important factor to affect the result of performing quantum control on infinitesimal quanta with the method of the present invention. Conventionally, time has long been merely a gauge of observing and researching quantum mechanics. In the present invention, time has been adopted as a decisive parameter that affects diffusion of particles and resonance wave during a reaction period, wherein the time unit is “second”. It is found in preceding experiments that reaction for a long time leads to a wavy effect. Consequently, a reaction time needs to be accurately controlled so as to obtain a desired result in the wavy effect. The reason of causing such wavy effect can be deduced that waves in the space are diffused regularly to maintain a balance status. Provided that the reaction time is not limited, a reaction result is expected to return to a steady and balance status without producing any effective change. Thus the reaction time is necessitated to be controlled. Besides, in practical reaction, different reaction spaces may be utilized cooperatively in which two different times are to be controlled accordingly. The two different times include a reaction time and a time interval for controlling a connecting reaction among multiple three-dimensional closed spaces. The time interval is primarily intended to enable to-be-processed matters to break away from the reaction space, so as to achieve continuous equilibrium with electromagnetic waves in atmosphere and satisfy traditional thermodynamic principles, thereby obtaining stable reaction results. Accordingly, in the parameter control step 4, wherein “second” is used as the time unit for control, a first reaction parameter and a second reaction parameter are provided. When the first reaction parameter occurs, wave control is performed on a corresponding one of the at least one closed space provided in the independent reaction space provision step 2. More specifically, a variation of equilibrium reaction between particles and waves in each of the at least one three-dimensional closed space is captured under the limitation of time. When the second reaction parameter occurs, given that a plurality of three-dimensional closed spaces are provided in the independent reaction space provision step 2, the time interval between the use of one closed space and the use of a next closed space is controlled, so as to enable continuous reaction with waves and particles in the atmosphere and thereby achieve balanced and stable reaction.

According to the foregoing steps, a to-be-processed matter 5 (e.g., mineral water) is placed in the at least one three-dimensional closed space provided in the independent reaction space provision step 2. Under the limitation of space and time, and by virtue of the lattices (pores), or slit structures, formed in the asymmetrically arrayed at least one reaction element 61, interference and superposition take place as a result of potential differences. Consequently, diffused waves and particles are enhanced and become wave beams. Under the action of the wave beams and the control of the first reaction parameter provided in the parameter control step 4, the properties of the to-be-processed matter 5 are modified after processing, thus producing a processed matter 5′. In brief, the present invention, based on fundamental physics and Young's double-slit theory, with multiple pores formed on metal plates in a consistent and tight arrangement, is intended to destroy or debond attraction (bonding) among particles by the actuation of time (second) and space (three-dimensional), and to immediately bring another bonding or particle at the moment of the disappearance of previous bonding based on the law of conservation of matter, whereby to change chemical compound characteristics (or entire clusters) of a matter; more specifically, wave frequency and particles that pass through the pores of the metal plates based on the double-slit theory are to be controlled and sorted. Wave length and size of the particle reach a range of quantum. To affect and interact with a hydrogen bond generated by hydrogen and oxygen of water molecule clusters, a cage-like hydrate of the water molecule clusters is involved therein. The cage-like hydrate is a pentagonal decahedron consisted of hydroxide ion of water. Each water molecule has three hydrogen bonds, and each face has a radius Rc=2.6A; therefore, with the structure of the plurality of mesh plates 611 and metal plates 612, the waves beams and sorted and particles generated from the plurality of mesh plates and the metal plates cooperatively reaching a wavelength (wave frequency) that corresponds to a hydrogen bond, so as to change the cage-like water molecule clusters to be smaller cage-like elements under effectively actuating in a direction of the wave beams. Consequently, for the so-called control range of wave frequency, whether a bonding of the particles and wave frequency passing through the metal plates based on the double-slit theory with the to-be-processed matter is corresponding to the effect of quantum reaction probability where external wave frequency being bunched and sorted is in constructive and destructive interference with waves of chemical compound molecules. Accordingly, the to-be-processed matter 5 (i.e., mineral water) treated with the above method is capable of altering the nuclear magnetic resonance frequency and electric properties thereof are altered, the dimensions of water molecule clusters in the mineral water are standardized, and the percentage contents of trace elements in the mineral water are changed. In addition, as the original mineral water molecules have been processed by externally applied electromagnetic waves, the energy level and the intensity of orbital electron cloud of the mineral water molecules are both changed. The aforesaid phenomena prove that infinitesimal quanta have been effectively controlled. (Note: By varying the number of seconds specified by the first reaction parameter and the shapes of the reaction elements, the physical properties of the mineral water can be modified differently so as to produce different control effects as described below.)

Accordingly, the present invention utilizes the independent reaction space provision step 2 to provide potential differences through angles formed by the three-dimensional closed spaces arranged in a cubic array, and utilizes the reaction elements 61 (there are totally eight different geometric shapes) of the infinitesimal-quantum kinetic energy enhancement step 3 with individual systems (same geometric shapes belong to a same system) provided on six inner surfaces of the cubic closed space, the first and second reaction parameters of the parameter control step 4, and the plurality of three-dimensional closed spaces operated in combination for providing various control parameters.

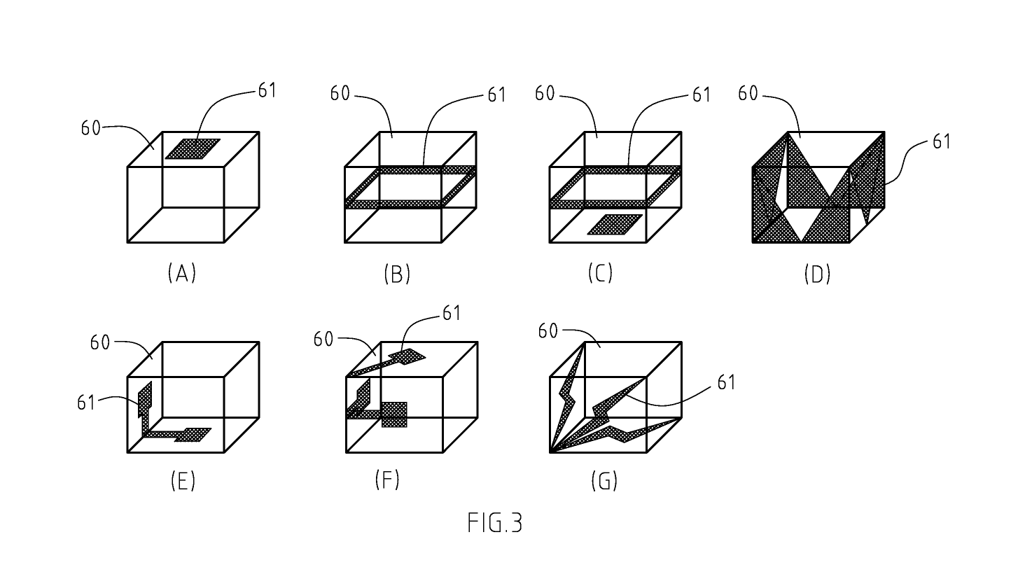

Please refer to FIGS. 2A, 2B and FIGS. 3A to 3G for a device using the foregoing method of the present invention. As shown in the drawings, a device 6 for performing quantum control on infinitesimal quanta according to the present invention includes a three-dimensional closed space 60, a plurality of reaction elements 61, and a man-machine interface control mechanism 62. As shown in FIG. 2A, the three-dimensional closed space 60 has a cubic shape and is made of a transparent material and is formed with an inlet 601 through which a to-be-processed matter can be put into the closed space 60. The closed space 60 defines therein a range of action for particles and waves of infinitesimal quanta, i.e., (x, y, z) of a wavefunction, whereby balanced reaction conditions are obtained. As shown in FIGS. 3A through 3G, the plural reaction elements 61 have different shapes and are provided on at least one inner surface of each of the three-dimensional closed spaces 60 and arranged as asymmetric arrays, thus causing particles and waves to move and exhibit potential differences. In addition, each of the plural reaction elements 61 includes a plurality of black mesh plates which are overlapped to form numerous complicated slits and pores capable of producing enhanced interference and superposition effects. As shown in FIGS. 3A to 3G, each reaction element 61 can have a dumbbell shape, a cross shape, a triangular shape, a rectangular shape, a square shape, a lightning shape, and so on. It is worth mentioning that metal plates (made of aluminum in the present embodiment) each having an irregular surface are sandwiched between the mesh plates of each reaction element 61 to enable reflection of low-energy waves and particles in space. Thus, the low-energy waves and particles act repeatedly in each reaction element 61 until their energy levels (frequencies) are increased through repeated interference and superposition to such extent that the originally low-energy waves and particles are now able to penetrate the metal plates. As a result, the kinetic energies of the waves and particles are enhanced. In practice, the metal plates sandwiched between the mesh plates are arranged equidistantly or in an arithmetic or geometric progression.

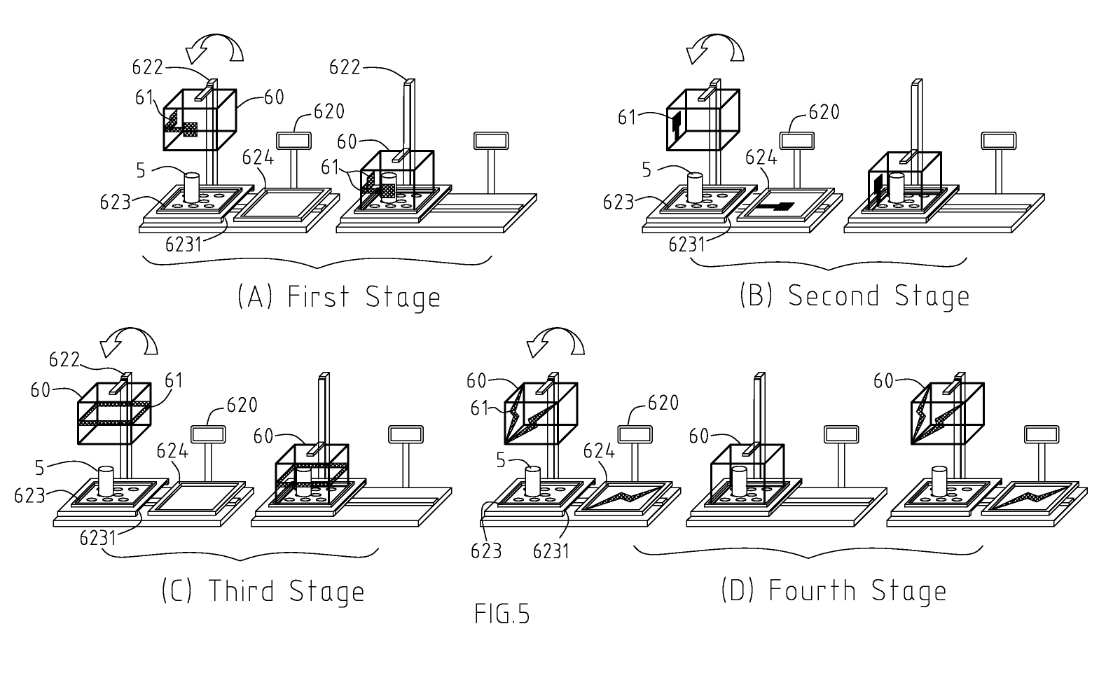

Referring back to FIG. 2B, the man-machine interface control mechanism 62 includes a man-machine interface control unit 620 and an automatic catch and transport unit 621. The man-machine interface control unit 620 includes a control circuit and a starting switch (not shown). The control circuit is preset with necessary parameters, which include a reaction time and a time interval for controlling a connecting reaction between two three-dimensional closed spaces 60. The starting switch is configured for turning on and off a power source. The automatic catch and transport unit 621, which is connected to and controlled by the man-machine interface control unit 620, includes a pneumatic lift bar 622 and a transport mechanism. The transport mechanism includes a first transport tray 623 and a second transport tray 624 to be nested in the first transport tray 623. The pneumatic lift bar 622 is connected with the three-dimensional closed space 60. The first and second transport trays 623, 624 operate by a transmission member (not labeled) and in conjunction with the pneumatic lift bar 622 to transport the to-be-processed matter along a predetermined direction. More specifically, while the pneumatic lift bar 622 is lowered such that the three-dimensional closed space 60 covers the first transport tray 623, the second transport tray 624 is slid synchronously into a receiving groove 6231 (shown in FIG. 5) of the first transport tray 623. When reaction is completed, the pneumatic lift bar 622 is lifted such that the three-dimensional closed space 60 leaves the first transport tray 623, the to-be-processed matter is transported to the next processing step.

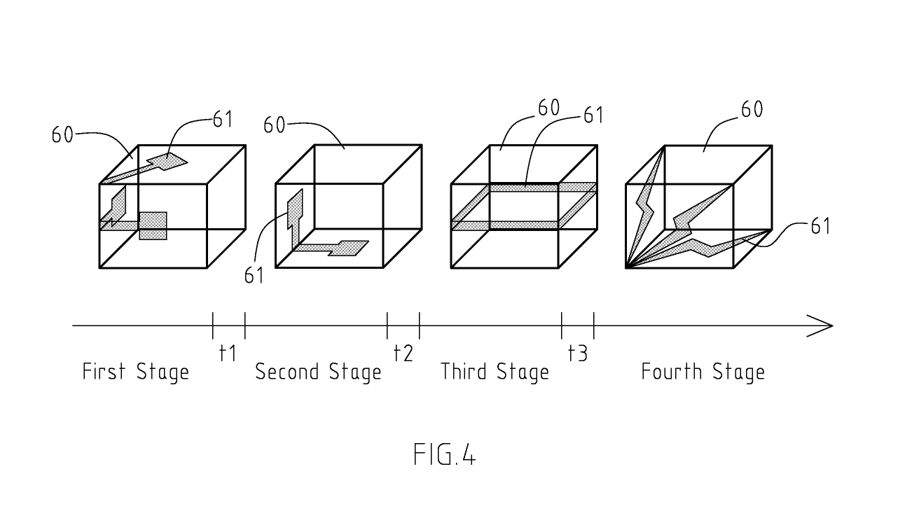

FIG. 4 illustrates the parameter control step 4 of the method of the present invention, showing time interval control between consecutive uses of several independent three-dimensional closed spaces 60. FIG. 4 depicts a four-stage processing process, wherein each stage involves a first reaction parameter and a second reaction parameter, and the control is carried out with “second” being the time unit. When the first reaction parameter occurs, wave control is performed on a corresponding one of the plural three-dimensional closed spaces 60 provided in the independent reaction space provision step 2. More specifically, by means of the differently shaped reaction elements 61 (such as those shown in FIGS. 3A to 3G with the rectangular shape, the lightning shape, and so on), a variation of equilibrium reaction between particles and waves in each of the three-dimensional closed spaces 60 is captured under the limitation of time. When the second reaction parameter occurs, the time intervals (t1, t2, t3) between the uses of the plural three-dimensional closed spaces 60 provided in the independent reaction space provision step 2 are controlled, so as to enable continuous reaction with waves and particles in the atmosphere and thereby achieve a balanced and stable reaction.

Please refer again to FIG. 4 in combination with FIGS. 5A to 5D for an illustration of how a to-be-processed matter 5 (e.g., mineral water) undergoes a four-stage processing process by the device for performing quantum control on infinitesimal quanta according to the present invention. To begin with, the starting switch of the man-machine interface control unit 620 is turned on so as for the pneumatic lift bar 622 to lift open a first three-dimensional closed space 60. After the to-be-processed matter 5 is put in place, the first three-dimensional closed space 60 is lowered by the pneumatic lift bar 622 so as to cover the to-be-processed matter 5. Meanwhile, the second transport tray 624 is slid synchronously into the receiving groove 6231 of the first transport tray 623 (first stage; FIG. 5A). During a preset reaction time (i.e., the first reaction parameter), particles and waves in the first three-dimensional closed space 60 pass through the slits of the plural reaction elements 61, and free waves in the space are thus adjusted to produce interference and superposition effects. Then, the first three-dimensional closed space 60 is lifted opened and stays open for a preset time interval (i.e., the second reaction parameter) so as to reach equilibrium with electromagnetic waves in the atmosphere. Following the same procedure, the to-be-processed matter 5 enters second and third three-dimensional closed spaces 60 (second and third stages; FIGS. 5B, 5C) and a fourth three-dimensional closed space 60 (fourth stage; FIG. 5D) for further processing. With different reaction times (i.e., the first reaction parameters) and different time intervals (i.e., the second reaction parameters (t1, t2, t3) shown in FIG. 4), the physical properties of the to-be-processed matter 5 are modified. According to the law of conservation of energy, assimilation of matter cannot be attained without provision of basic kinetic energy. Therefore, in the method for performing quantum control on infinitesimal quanta according to the present invention, the acquisition of kinetic energy is realized in the following manner. Based on the concept of wavefunction control in quantum mechanics, three-dimensional multi-layer double-slit structures are designed in the present invention to adjust free waves in space. Then, through proper combination of reaction spaces and time parameters, photoelectromagnetic chain reactions take place to provide the resonance frequency required for assimilation, thereby modifying the physical properties of a matter to be processed.

Accordingly, the method of the present invention is further experimented, tested, compared, and analyzed as follows:
(A) Experimental data and testing method
   Processing matter: a bottle of mineral water of 600 c.c.
   Testing method: thoroughly test microscopic original molecules changes in status after quantum motion, processed with the various parameters as described above.
      1. Taking two bottles of mineral water both produced from a same batch number and water source, wherein one bottle is designated as an experimental group, while another one is designated as a control group.
      2. The two bottles are preserved under normal temperature with same conditions for preservation in all kinds of environments so as to prevent environmental influences.
      3. The experimental group is set in a reaction mechanism center (based on a reaction space capable of being completely covered), and perform a self-defined model 10M3 (reaction structure, space order, time seconds parameters) under the conditions of no additives added and unsealed.
      4. After the experimental group is being processed, send the experimental group together with the control group to be tested.
      5. Testing devices
         a. Nuclear magnetic resonance spectrometer (NMR 500): testing half-width waves before and after treatment for a investigating a size distribution ratio of water molecule clusters after being affected by quantum motion.
         b. ELS-MASS spectrometer: testing distribution of water molecule clusters and changes of the amount and arrangement of water molecules before and after treatment.
         c. LCR testing apparatus: testing changes of electrical ability of the mineral water (inductance, capacitance, resistance) before and after treatment, under the conditions of 100 Hz, 10V, an interval of 5 minutes).
         d. Trace elements concentration analysis (SGS): testing the amount of trace elements in the mineral water before and after treatment.
(B) Results and discussion

Original mineral water after processed through the 10M3 process shows discrepancies according to the physical and chemical property. The testing values are provided as follow:
3-1. Testing values of NMR:
   (1) Tested in D2O solvent: a half-width wave of original mineral water not being processed is 35.45 Hz at the peak of 4.799 ppm, while a half-width wave of the processed 10M3 mineral water reaches 46.36 Hz by an increase of 10.91 Hz.
   (2) Tested in DMSO solvent: a half-width wave of original mineral water not being processed is 20.75 Hz, while that of the processed 10M3 mineral water reaches 24.06 Hz by an increase of 3.31 Hz. (absorption peak at 3.931; 3.952 Hz, i.e., two types of DMSO solvents exist reaction between a solute and solvent)
   (3) The half-width waves as described above are both increased, that is, the size distribution ratio of the water molecule clusters expands after the process of 10M3.
   (4) The size of water molecule clusters and water molecule structure are related to each other, such as changes from the nutation field of hydrogen bond of water and particles thereof.
3-2. Testing values of ELS-MASS spectrometer: n in (H2O)n
   (1) In the original mineral water not being processed, absorbance of water molecule clusters reflected in x-ordinate of the mass spectrometry is 278.7 (n˜15) 390.9 (n˜22). Furthermore, absorbance at 138.5, 122.6, 104.7, 93.5 and 84.7 are relatively high.
   (2) In the processed 10M3 mineral water, absorbance of corresponding water molecule clusters is remarkably attenuated, and when m/z values ranged from 156 (n˜9) to 73.6 (n˜4), an absorbance peak becomes isometry (m/z value˜18). In addition to the value of 138.4 remains similar intensity, others are shown to be attenuation.
   (3) According to the date as stated above, after the water molecule clusters being treated through the process of 10M3, the distribution of the water molecule clusters shows remarkable discrepancies before and after treatment. For instance, size and arrangement of one water molecule is different after treatment, which expands in a direction towards large and small portions thereof.
3-3. Testing values of LCR analysis (L represents inductance, C represents capacitance, R represents serial/parallel resistance): the unprocessed original water and the processed 10M3 water are treated to show changes of LCR values with respect to time under the conditions at 100 Hz, 10V, and an interval of 5 minutes.
   (1) Starting value: at beginning (t=0 minute) differences in values are slightly increased for inductance and capacitance, but reduced for resistance; conductivity is estimated to be slightly increased.
   (2) After 5 minutes: differences in values are slightly reduced for capacity and inductance, but increased for resistance, that is, conductivity is reduced.
   (3) After 10 minutes: differences in values are approximately balanced for capacitance and inductance, and water solution is in a balanced state.
   (4) After 15 minutes: differences in values are decreased from the balanced state for capacity and inductance, but reach the maximum high at 0.4864 kO for resistance.
   (5) After 20 minutes: differences in values are increased towards the balanced state for capacity and inductance, but reduced again for resistance, that is, conductivity increases.
   (6) After 25 minutes: differences in values are in the balanced status for capacity, inductance, and resistance (same as the state as after 10 minutes).
   (7) After 30 minutes: differences in values are in the balanced status for capacity and inductance, but reach the maximum low at −0.4905 kO for resistance; at this state, conductivity of the mineral water greatly increases and is better than the unprocessed mineral water.
      With respect to electric properties, when differences in values increase for capacitance and inductance, but decrease for resistance, conductivity of water then increases. On the contrary, when differences in values decrease for capacitance and inductance, but increase for resistance, conductivity of water then decreases. The processed 10M3 water is slightly changed in LCR value, and such phenomenon may influence nano-biological function thereof. Furthermore, according to the research of Russian scholar G. N. Sankin and V. S. Teslenko, it is found that conductivity of water molecule cluster is fluctuated subject to the change of a micro magnetic field.
3-4. Trace elements of the mineral water tested by international test organization SGS:
   (1) Trace elements in the unprocessed original mineral water and the processed 10M3 mineral water are varied as indicated in the report provided by SGS.
   (2) One of significant changes is indicated to be an increase in the concentration (unit is ppb) of trace elements, as stated below: increase by 0˜10%: boron, chromium, sodium
      10˜20%: calcium, cobalt, potassium
      20˜30%: copper, iron, nickel
      30˜40%: Vanadium
3-5. Results:

Based on the quantum mechanics used to describe movements of particles, and modification of the parameters, a mechanism to affect quantum patterns is therefore created, including time, space, complex interference and refraction structure, in which covers a design for interference and refraction structure, a design for reaction spaces, and above all, time parameters including operation time and time intervals that are defined by experiments and tests, conducted with a great deal of time and patience, to find out differences of every second.

Hence, the method for performing quantum control on infinitesimal quanta according to the present invention is capable of affecting molecular bonds and element properties of matter for different purposes and thereby controlling the wavefunction to provide different energies. Apart from the above-given example of mineral water, the present invention is also applicable to providing assistance to environmental improvement techniques, agricultural cultivation and planting techniques, traditional medical techniques, and so forth. Take the rusting of iron for instance. When water molecules come into contact with iron, hydrogen atoms in the water molecules are ionized such that the oxygen atoms bond with iron to form iron oxide. If a resonance wave capable of inhibiting the activity of oxygen or iron atoms is provided, oxidation will be slowed down to produce an anti-rust effect. As another instance, the present invention can also decompose harmful compound molecules into non-toxic substances through wave resonance, thus removing pollutants such as dioxin and ammonia, nitrogen, and surfactant in water. Furthermore, the physical properties of a water body can be modified (e.g., molecule clusters can be standardized, resonance frequency enhanced, polarity altered, electric properties varied, proportion of trace elements adjusted, and dissolution rate changed) by varying the combination of different parameters according to the item(s) to be modified. Thus, fungi and algae in the water body can be effectively vitalized to accelerate the metabolic cycle, and increase the self-purification capacity, of the water body. Consequently, by means of the original metabolic cycle, dissolved oxygen can be increased, ammonia and nitrogen reduced, bad odor eliminated, cloudiness lowered, and chemical pollution abated, wherein the related items include but are not limited to pH, acidity, alkalinity, chloride, suspended solid (SS), dissolved solid (DS), chemical oxygen demand (COD), biochemical oxygen demand (BOD), nitrogen, phosphorus, sulfur compounds, heavy metals, radioactive substances, detergents, and other pollutants. As a result, with the improvement of water quality, rivers are vivified, and their biotic indices are raised, thereby restoring the natural state of rivers, i.e., a state in which fish and shrimps can be found. Besides, the present invention is equally suitable for use in the medical field as well as agricultural cultivation, livestock raising, and aquaculture. In these cases, wave control and the principle of resonance can be applied according to the desired influences and actions, in conjunction with control programs of different functions, so as to achieve assimilation and regulation effects.

As described above, the method and device for performing quantum control on infinitesimal quanta according to the present invention achieve the intended objectives and meet the requirements for patent application. However, it is understood that the foregoing description is only illustrative of the preferred embodiments and is not to limit the scope of the present invention. All equivalent changes or modifications which are based on the contents disclosed herein and do not depart from the spirit of the present invention should be encompassed by the appended claims.

What is claimed is:

1. A method for performing quantum control on infinitesimal quanta, wherein quantum control is performed on infinitesimal quanta so as to modify properties of a to-be-processed matter, the method comprising:
an independent reaction space provision step comprising: providing at least a three-dimensional closed space as a wavefunction having x-axis, y-axis, and z-axis that are equal in length with each other, wherein each said closed space defines therein a range of action for particles and waves of infinitesimal quanta, and the to-be-processed matter is placed in the at least a three-dimensional closed space for reaction;
an infinitesimal-quantum kinetic energy enhancement step, comprising: providing reaction elements of different geometric shapes on at least one of adjacent inner surfaces of each said closed space, wherein each said reaction element is consisted of a plurality of mesh plates being overlapped in a predetermined order, and metal plates sandwiched between the mesh plates, each of the mesh plates forming multiple pores such that, while particles and waves in the each said closed space pass through tiny lattices formed by the overlapped mesh plates and arranged in an asymmetric way to move and exhibit potential differences in a probabilistic quantum effect when performing Young's double-slit experiment, free waves in the each said closed space are adjusted so as to produce interference and superposition effects, thereby creating wave beams as a basis of infinitesimal-quantum reaction, whereby the wave beams, waves being sorted, and particles from the plurality of mesh plates and the metal plates cooperatively reaching a wavelength (wave frequency) that corresponds to a hydrogen bond thereby to change characteristics or entire clusters of chemical compounds of the to-be-processed matter and to form smaller cage-like elements under effectively actuating in a direction of the wave beams; and
a parameter control step being counted by time with a time unit of “second”, comprising: a first reaction parameter defined by a time that the to-be-processed matter remains in the three-dimensional closed space, and a second reaction parameter defined by a time that the to-be-processed matter is exposed to the atmosphere;
wherein the particles and waves of the infinitesimal quanta in the universe through the plurality of mesh plates, double-slit reaction and repeatedly reflection or sorting between the metal plates exhibit directionality and specific wave frequency, and after reaction with the first reaction parameter observe change of physical and chemical characteristics of the to-be-processed matter during which quanta in atoms is in a process of permutation, or electron energy levels are in drastically change, or covalent bonds among atoms are cracked, and polar bonds of the chemical compounds bonding with hydrogen bonds exhibit greater polarity through enhanced resonance of effectively bunching and directional wave frequency and particles, and through constructive interference of effectively bunching and directional wave frequency and particles the chemical compounds resonate with greater amplitudes causing agitation of chemical compound particles, whereby enhancing the physical and chemical characteristics of the chemical compounds, or through destructive interference of effectively bunching and directional wave frequency and particles the polarity of the chemical compounds transiently disappears where the chemical compounds temporarily lost attracting and spinning reaction and thus cluster structure of the chemical compounds and the chemical compound particles is being changed so as to realize quantum control on infinitesimal quanta.

2. The method of claim 1, wherein the plurality of mesh plates are made of nylon and overlapped in the predetermined order such that each adjacent mesh plate has different number of the pores so as to form numerous said slits and pores which are configured in a complicated manner and capable of producing enhanced interference and superposition effects.

3. The method of claim 2, wherein the metal plates each having an irregular surface and made of aluminum are configured to enable low-energy waves and particles to be reflected in each said closed space and act repeatedly in the reaction elements until energy levels (frequencies) of the low-energy waves and particles are increased through repeated interference and superposition to such extent that the originally low-energy waves and particles can now penetrate the pores of the metal plates, thereby enhancing kinetic energy of the wave frequency and particles and sorting specific wave frequency, and a consistent arrangement of the pores enabling the particles and wave frequency passing therethrough to be bunching and directionality.

4. The method of claim 3, wherein the metal plates are sandwiched between corresponding said mesh plates equidistantly or in an arithmetic or geometric progression.

5. The method of claim 2, the plurality of mesh plates are overlapped in the predetermined order such that one of the mesh plates having 120 stitches per square inch is overlapped with another one of the mesh plates having 100 stitches per square inch.

6. The method of claim 1, wherein the second reaction parameter of the parameter control step is intended to provide and perform accordingly time interval control between consecutive uses of a plurality of said closed spaces, so as to achieve continuous equilibrium with electromagnetic waves in atmosphere and satisfy traditional thermodynamic principles, thereby obtaining stable reaction results.

7. The method of claim 6, wherein the first reaction parameter varies with the to-be-processed matter as well as the mesh plates and metal plates provided in the infinitesimal-quantum kinetic energy enhancement step.

8. The method of claim 1, wherein each said three-dimensional closed space has a cubic shape.

9. The method of claim 1, wherein the mesh plates are black.

10. The method of claim 8, wherein the reaction elements on the at least one of adjacent inner surfaces of each said three-dimensional closed space are arranged as an asymmetric array, thus causing particles and waves to move and exhibit potential differences.

11. A device for performing quantum control on infinitesimal quanta, wherein quantum control is performed on infinitesimal quanta so as to modify properties of a to-be-processed matter, the device comprising:
at least a three-dimensional closed space formed with an inlet such that the to-be-processed matter is placed into each said three-dimensional closed space through a corresponding said inlet;
at least a reaction element provided on an inner surface of each said three-dimensional closed space, wherein each said reaction element is consisted of a plurality of mesh plates being overlapped in a predetermined order, and metal plates sandwiched between the mesh plates, each of the mesh plates forming multiple pores; and
a control mechanism comprising:
a man-machine interface control unit comprising a starting switch and a control circuit controlling a reaction time; and
an automatic catch and transport unit connected to and controlled by the man-machine interface control unit and comprising:
a pneumatic lift bar connected with the at least a three-dimensional closed space for moving the at least a three-dimensional closed space; and
a transport mechanism operating in conjunction with the pneumatic lift bar so as to transport the to-be-processed matter along a predetermined direction.

12. The device of claim 11, wherein each said three-dimensional closed space has a cubic shape and is made of a transparent material.

13. The device of claim 11, wherein each said reaction element comprises a plurality of overlapped mesh plates and has a geometric shape selected from the group consisting of a dumbbell shape, a cross, a triangle, a rectangle, a square, a trapezoid, and a lightning shape.

14. The device of claim 11, wherein each of the plurality of mesh plates is made of nylon, and the plurality of mesh plates are overlapped in the predetermined order such that each adjacent mesh plate has different number of the pores.

15. The device of claim 11, wherein each of the metal plates has an irregular surface and is made of aluminum.

16. The device of claim 11, wherein the transport mechanism of the automatic catch and transport unit comprises a first transport tray and a second transport tray to be nested in each other immediately by a transmission member and operating in conjunction with the pneumatic lift bar such that the at least a three-dimensional closed space is moved onto the first transport tray so as to proceed to quantum control on the to-be-processed matter.
